(19) United States
(12) Patent Application Publication
(10) Pub. No.: US 2008/0019891 A1
(43) Pub. Date: Jan. 24, 2008

(54) Copper recoery method and system therefor

(76) Inventors: Shenjung Huang, Taipei (TW); Da Jiang Chang, Taipei (TW)

Correspondence Address: HUANG, SHENJUNG, 4F., NO. 177, HO PING, SEC. 2, TAIPEI, 106, omitted

(21) Appl. No.: 11/645,737

(22) Filed: Dec. 27, 2006

(30) Foreign Application Priority Data
Jul. 18, 2006 (TW) 095127938

(51) Int. Cl. C22B 15/00; B01J 8/00

(52) U.S. Cl. 423/23; 422/187; 422/211

(57) ABSTRACT

A process for copper recovery includes mixing a sludge cake with an acidic copper-containing rinsing waste liquid to form slurry; reacting the slurry with acidic SPS-containing effluent, nitric acid, sulfuric acid and liquid alkali to form a copper-containing reaction product; press filtering the obtained-above copper-containing reaction product to obtain a copper oxide-containing solid and a filtrate.

### FIELD OF THE INVENTION

The present invention relates to a copper recovery method and a copper recovery system. More specifically, the invention relates to a system and a process that respectively recover a highly valuable copper from a copper-containing waste or effluent without any output of sludge and/or slurry or other secondary wastes.

### DESCRIPTION OF THE RELATED ART

As popularization and development of electronics go, the market value of circuit boards which are used in the electronics has exceeded over thousands dollars. However, chemicals and materials used for the manufacture of the circuit board produce a lot of poisonous wastes in either liquid form or solid form, in which heavy metals such as copper, lead or nickel are contained. If such great amount of heavy metals cannot be well treated, then serious environmental pollution will occur to endanger human's health. Furthermore, in terms of increasing prices of the heavy metals, recovery of the highly valuable copper from the effluent or waste will add profit to the manufacturer itself.

Besides, the manufacture of PCB utilizes a number of processes which use various strong acids and/or alkali so that the wastes from various processes are different in contents, concentrations and species percentage. Most the effluents or waste contain high concentration of heavy metals, which are treated by outsiders.

Various approaches have been proposed for treating these process wastes for sake of reducing treatment costs.

For example, it is reported that a copper chloride-containing waste liquid is mixed with an alkali solution to obtain copper oxide. JP patent no. 2002-211920 discloses the recovery of copper oxide from a copper chloride-containing etching waste liquid. The etching waste liquid is mixed with an alkali aqueous solution of higher than pH 11 at 50° C. Copper ions dissolved in the mixed solution are transformed into copper oxide after sedimentation. The disclosure thereof is incorporated herein by reference.

TW patent no. 580484 teaches one or more strong acids selected from sulfuric acid, nitric acid and hydrogen chloride, and peroxides (as a strong oxidant) are mixed with a copper-containing sludge that contains polymeric coagulants to release a mixture having the polymeric coagulant and metal hydroxide. Then, the mixture is adjusted to be an acidic liquid to separate the polymeric coagulant from the acidic liquid. After the acidic liquid turns into alkali liquid by pH adjustment, copper oxide is obtained. Other processes that use strong acids or strong oxidants to recover copper from copper-containing sludge are also disclosed in U.S. Pat. No. 6,027,543, U.S. Pat. No. 4,670,052 and GB patent no. 2,118,536. Those disclosures thereof are incorporated herein by reference. The use of the strong oxidants in the above recovery processes generate a great number of oxidizing gases and thus needs further installation of scrubber towers to collect those harmful gases and prevent them from spreading out over the manufacture plant.

In addition, all of the above processes deal with one process waste, for example, the copper sludge or slurry, the copper chloride waste solution or copper-containing etching waste liquid. Other process wastes still need to be treated by outsiders, so that the relevant cost is still significant high.

Among the process effluents or wastes generated from the printed circuit board manufacturers, acidic copper-containing rinsing waste liquid occupies the most of total volume. However, it has never been the target to be recovered due to its low copper content of about 200 ppm. If such great amount of acidic copper-containing rinsing waste liquid can be well treated, it significantly helps reduce the amount of outsourcing treatment.

Therefore, there is a need of a waste treatment that can deal with a plurality of different process wastes in the same treatment system.

### SUMMARY OF THE INVENTION

Therefore, it is an object of the invention to provide a system and a process for copper metal recovery that recovers highly valuable copper metal from copper-containing wastes or effluents with low treatment agent cost, without any output of slurry or other secondary pollutants.

It is another object of the invention to provide a system and a process for copper metal recovery that solves wastes or effluents coming from at least one process in a printed circuit board manufacture plant, substantially reducing the waste treatment cost and even increasing the overall profit due to the recovered copper metal.

Still, it is another object of the invention to provide a system and a process for copper metal recovery that solves great amount of acidic copper-containing rinsing waste liquid which is a major waste in the printed circuit board manufacture plant.

In order to achieve the above and other objectives of the invention, the process for copper metal recovery at least includes mixing a sludge cake with an acidic copper-containing rinsing waste liquid to obtain a slurry; reacting SPS-containing waste liquid, nitric acid, sulfuric acid, liquid alkali with the slurry to obtain a copper oxide-containing reaction product; and press filtering the obtained copper oxide-containing reaction product to obtain a copper oxide-containing solid and a filtrate.

According one aspect of the invention, one weight part of sludge cake is mixed with at least one weight part of acidic copper-containing rinsing waste liquid while stirring thoroughly to form slurry. Alternatively, one weight part of dry sludge is ground into powders and then added into at least one weight part of acidic copper-containing rinsing waste liquid to obtain slurry.

According to another aspect of the invention, pH value of the obtained slurry is controlled at higher than 2.

According to another aspect of the invention, the alkaline high-concentration sludge and acidic copper-containing rinsing waste liquid are used to control the pH value of the obtained slurry.

According to another aspect of the invention, a drying process is further performed after press filtering to obtain a copper oxide solid with more than 20 wt % of copper oxide and about 10% of water.

According to one aspect of the invention, more than 0.5 weight parts of SPS acidic waste liquid, nitric acid and sulfuric acid, at least 17% of liquid alkali based on the total weight of SPS-containing acidic waste liquid, nitric acid, sulfuric acid and slurry are used.

According to one aspect of the invention, the pH value during reaction is kept higher than 12.

According to one aspect of the invention, the copper-containing reaction product obtained after the reaction is controlled between 8.5 and 9.5.

According to one aspect of the invention, the copper-containing solid contains about 50-70 wt % water and more than about 10 wt % of copper.

A system for copper metal recovery according to one preferred embodiment of the invention at least includes a slurry preparing unit, a reaction unit and a press filtering unit. The sludge cake and acidic copper-containing rinsing waste liquid are mixed in the slurry preparing unit to obtain slurry. The reaction unit connects to the slurry preparing unit and the press filtering unit. The slurry, liquid alkali, SPS-containing acidic waste liquid, nitric acid and sulfuric acid react with one another to obtain a copper oxide-containing reaction product which is then press filtered in the press filtering unit to obtain a copper oxide-containing solid.

According to one aspect of the invention, the system for copper metal recovery further includes a slurry pipe connected to a reactor to charge the slurry into the reactor.

According to one aspect of the invention, the system for copper metal recovery further includes an acidic copper-containing rinsing waste liquid pipe to charge the acidic copper-containing rinsing waste liquid into the reaction unit to control the pH value therein.

According to one aspect of the invention, the slurry preparing unit connects to a sludge cake delivery belt, an acidic copper-containing rinsing waste liquid pipe and a slurry pipe.

According to one aspect of the invention, the reaction unit connects to a slurry pipe, a liquid alkali pipe, a SPS pipe, a nitric acid pipe, a sulfuric acid pipe and a copper-containing reaction product pipe.

According to one aspect of the invention, the pressure filtering unit connects to a copper-containing reaction product pipe, a copper-containing solid pipe and a filtrate pipe.

According to one aspect of the invention, the reaction unit connects to the slurry pipe, a liquid alkali pipe, a mixture pipe and a copper oxide-containing reaction product pipe.

According to one aspect of the invention, the liquid used in the invention is an acidic copper-containing rinsing waste liquid.

### BRIEF DESCRIPTION OF THE DRAWINGS

FIG. 1 is a schematic view of a copper recovery system according to a first preferred embodiment of the invention; and

FIG. 2 is a schematic view of a copper recovery system according to a second preferred embodiment of the invention.

### DETAILED DESCRIPTION OF THE EMBODIMENT(S)

A PCB manufacture plant typically has a wastewater treatment unit for roughly treating various process waste liquids or water before those waste liquids are discharged or sent out for further treatment. The waste liquid or water includes a number of heavy metals such as copper, tin, or lead. A waste mixture collected in the wastewater treatment unit come from various manufacture processes and has a pH value of 2-3 that usually increases to 7-9 by adding iron chloride. A polymeric coagulant is added into the waste mixture later to form concentrated sludge. After pressure filtering, a sludge cake of more than 70% water is obtained. The filtrate then reaches the discharge standard.

The waste liquid/effluent to be treated in the treatment process or the treatment system according to the invention includes copper-containing solid waste, high-concentration strong acidic waste liquid, sludge, high-concentration slurry, acidic photolithography waste liquid, sludge cake and/or concentrated slurry. Optionally, high-concentration nitric acid liquid and copper-containing solid waste sludge cake and acidic copper-containing rinsing waste liquid.

The term “high-concentration strong acid waste liquid” used in the invention refers to an undiluted high-concentration strong acid waste liquid generated in any PCB manufacture processes, such as acidic lithography process and lead flame manufacture. The high-concentration strong acid waste liquid includes nitric acid, sulfuric acid and hydrogen chloride.

The term “copper-containing solid waste” used in the invention refers to solid waste copper materials or foils from cutting, laminating, shaping, trimming and quality control testing.

The term “liquid alkali” used in the invention refers to more than about 45% liquid strong alkali, such as sodium hydroxide and potassium hydroxide. The term “solid alkali” is strong alkali such as sodium hydroxide and potassium hydroxide.

The term “sludge” used in the invention refers to the one obtained by adding polymeric aggregators into a PCB wastewater unit under alkaline condition. The sludge has 3-5% of copper content.

The term “slurry” used in the invention refers that is formed by thoroughly mixing the sludge cake with the acidic copper-containing rinsing waste liquid to form. The slurry has a concentration that mixer' blades can stir the slurry and be pumped to the reactor. The sludge can be added at that moment to increase copper content of slurry and consume the sludge.

The term “sludge cake” used in the invention refers to a solid in form of cake, which is obtained after pressure filtering and has more than 50% of water and more than about 7% of copper.

The term “sludge cake” used in the invention refers to that is obtained by pressure filtering the sludge. The sludge cake contains about 70% of water, about 7% of copper, and about pH 7.5-9. Similarly, “dry sludge” is that is obtained by dehydrating the sludge, with about 10% of water content and about 14% of copper.

[Copper Recovery Process]

According to the invention, the copper recovery process according to the invention at least includes mixing a sludge cake with an acidic copper-containing rinsing waste liquid to form a slurry (step of slurry preparation); reacting SPS-containing waste liquid, nitric acid, sulfuric acid, liquid alkali and slurry to form a copper oxide-containing reaction product (step of reaction); pressure filtering the obtained copper oxide-containing to form a copper oxide-containing solid and a filtrate (pressure filtering step); dry the above copper oxide-containing solid to obtain a copper oxide solid (during step). The content of copper oxide based on copper oxide solid is more than 20 wt %, and the water is about 10 wt %.

In one embodiment of the invention, at the step of forming the slurry, it is preferable to thoroughly mix one weight part of sludge cake with at least one weight part of acidic copper-containing rinsing waste liquid while stirring to form slurry. Alternatively, one weight part of dry sludge is ground into powders and then added into at least one weight part of acidic copper-containing rinsing waste liquids to form slurry. The pH value of the obtained slurry is controlled at higher than 2. The alkaline high-concentration sludge and acidic copper-containing rinsing waste liquid are used to control the pH value of the obtained slurry.

More than 0.5 weight parts of SPS-containing acidic waste liquid, nitric acid and sulfuric acid, at least 17% of liquid alkali based on the total weight of SPS-containing acidic waste liquid, nitric acid, sulfuric acid and slurry are used. This reaction is exothermal reaction, which heats up reaction unit to 70° C. The pH value during reaction is kept 12 or even higher than 12, at which condition copper oxide is formed.

The above SPS is a syndiotactic polystyrene which has melting point of 270° C., and excellent heat resistance, chemical properties and electrical properties. SPS-containing acidic waste liquid can be commercially available or an effluent generate in situ.

Nitric acid and sulfuric acid used in the invention can be commercially available or, individually or in combination, any acidic waste liquids generated in any PCB manufacture processes that use acidic solution or liquid for lithography, for example black/brown oxidation, through-hole plating, circuit plating and solder plating. The acidic photolithography waste liquid has a pH value of at least 0.3. It mainly contains sulfuric acid and/or nitric acid, and has copper of at least 200 ppm. It is noted that the acidic photolithography waste liquid is different from a pure acid that is commercially available and used as a treating agent in the art. The pure strong acid is extremely strongly erotic and generates a great number of heat and smokes that make the operating environment very dangerous. However, the acidic photolithography waste liquid used in the invention will not generate a lot of smokes and is not as highly erotic as the pure strong acid used in the art. In other words, the acidic photolithography waste liquid, in view of operating safety, is much safer than the pure strong acid in heavy metal recovery.

The addition of the slurry tends to reduce the pH value of the reactants. The amount of the liquid alkali can be adjusted to keep the pH value of the reactants at higher than 12. The pH value of the obtained copper oxide-containing reactants is kept at 8.5-9.5, by using the acidic copper-containing rinsing waste liquid.

The above copper-oxide containing reactants are pressure filtered to remove water and obtain copper oxide-containing solid, with about 50-70 wt % of water and about 10 wt % of copper. It is noted that the copper oxide-containing cake obtained after pressure filtering has other metal impurities in addition to copper oxide.

The term “copper oxide solid” herein refers to metal oxide containing mainly copper oxide and trace amount of other metal impurities such as iron, tin and lead.

[Copper Recovery System]

According to one aspect of the invention, the copper recovery system at least includes a slurry preparation unit, a reaction unit and a pressure filtering unit, and an optionally drying unit and a grounding unit.

The copper recovery system includes a slurry unit, a reaction unit and a pressure filtering unit. The slurry unit, the reaction unit and the pressure filtering unit are connected in sequence. Connecting piping is made of materials which has strong acid/strong alkali assistance. The diameter of the connecting piping is determined according to the amount of wastes to be treated, as long as the connecting piping is not clogged. The length of the connecting piping depends on the distance from exits of various waste liquids/wastes and relative arrangement of respective units.

The sludge cake and the acidic copper-containing rinsing waste liquid are mixed into the slurry preparation unit to form a slurry. The slurry preparation unit at least includes a stirring unit with a stirrer, and optionally includes a slurry storage unit connected to the stirring unit for storing the slurry formed in the stirrer.

The SPS-containing acidic waste liquid, nitric acid, sulfuric acid, liquid alkali and slurry react to one another in the reaction unit. The SPS-containing acidic waste liquid, nitric acid, sulfuric acid, liquid alkali and slurry are respectively charged into the reaction unit, preferably mixed before charging. The SPS-containing acidic waste liquid, nitric acid and sulfuric acid might come from high-concentration strong acid waste liquid. The high-concentration strong acid waste liquid is charged into the reaction unit to react with the liquid alkali and the slurry. Alternately, the SPS-containing acidic waste liquid, the strong acid and the liquid alkali are stored in respective containers to stabilize the flow thereof into the reaction unit. A copper oxide-containing reaction product container is used to store copper oxide-containing reaction product output from the reaction unit.

The copper oxide-containing reaction is subject to pressure filtration in a pressure filtering unit C to form a copper oxide-containing cake. The pressure filtering unit optionally connects to a drying unit (not shown) to dry up the above copper oxide-containing cake and then obtain a copper oxide solid.

In order to increase the yield of copper recovery and treatment performance of the remaining sludge, a copper-containing slurry input pipe can be additionally added to charge the copper-containing sludge into the stirring unit and increase the copper content in the slurry preparation unit. Alternately, a copper-containing sludge input pipe is configured to connect to the reaction unit for delivering the copper-containing sludge into the reaction unit.

Furthermore, high-concentration strong acid waste liquids generated from the acidic photolithography process and leadframe process are used to dissolve the copper-containing solid waste to form a copper solution which is subsequently added into the reaction unit to increase the copper recovery yield.

The addition of a great amount of liquid alkali into the reactor makes the pH value high. In order to reduce the pH value in the reactor, an acidic copper-containing rinsing waste liquid pipe is connected to the reactor so that the acidic copper-containing rinsing waste liquid in the slurry preparation step can be fed into the reactor to control the pH value in the reactor.

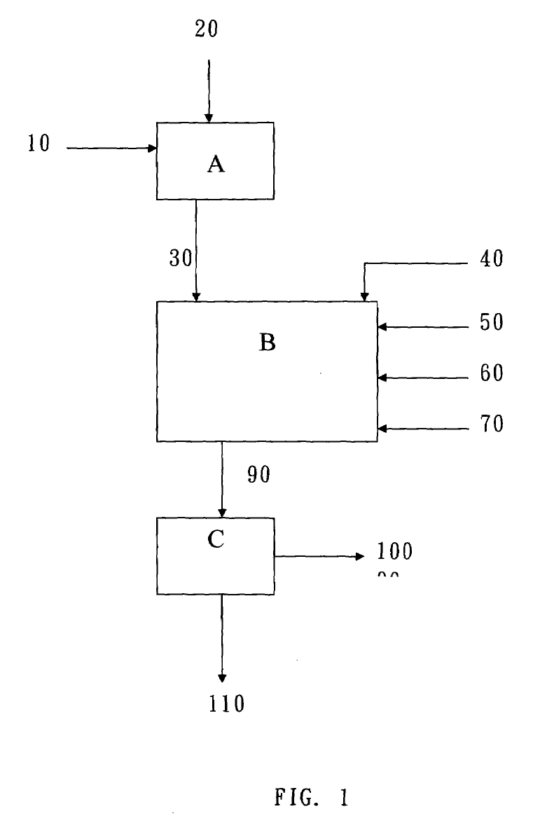

FIG. 1 is a schematic view of a copper recovery system according to a first embodiment of the invention.

Referring to FIG. 1, the slurry unit A includes a sludge cake delivery belt 10, an acidic copper-containing rinsing waste liquid pipe 20 and a slurry pipe 30. In another embodiment, the slurry unit A includes a stirrer (not shown) and a slurry storage container (not shown). The stirrer connects to the sludge cake delivery belt 10 and the acidic copper-containing rinsing waste liquid pipe 20. The slurry storage container connects to the slurry pipe 30, with a connection pipe connecting the stirrer and the slurry storage container.

In order to smoothly stir the sludge cake for preparing the slurry, the acidic copper-containing rinsing waste liquid 20 is opened to charge the acidic copper-containing rinsing waste liquid into the stirrer, and then the sludge cake delivery belt 10 is activated to charge the sludge cake into the stirrer. In another embodiment, the acidic copper-containing rinsing waste liquid can be filtrate output from the pressure filtering unit C.

The reactor B connects to the slurry pipe 30, a liquid alkali pipe 40, a SPS-containing acidic waste liquid 50, a nitric acid pipe 60, a sulfuric acid pipe 70 and a copper oxide-containing reaction product pipe 90.

The reaction unit B at least includes a reactor (not shown). The reactor preferably includes a stirrer (not shown) for complete reaction. The reaction unit B further includes a copper oxide-containing reaction product storage container connecting to the reactor.

In the case that the reaction unit B includes the reactor and the copper oxide-containing reaction product storage container, the reactor connects to the slurry pipe 30, the liquid alkali pipe 40, SPS-containing acidic waste liquid pipe 50, a nitric acid pipe 60 and a sulfur acid pipe 70. The copper oxide-containing reaction product storage container connects to the copper oxide-containing reaction product pipe 90, with a connecting pipe between the copper oxide-containing reaction product storage container and the reactor. Optionally, a water pipe (not shown) connects to the reactor to properly adjust the concentration of reaction product in the reactor.

The slurry, liquid alkali, SPS-containing acidic waste liquid, nitric acid and sulfuric acid are respectively charged into the reactor through the slurry pipe 30, the SPS-containing acidic waste liquid pipe 50, the nitric acid pipe 60 and the sulfuric acid pipe 70. After a certain period of time passed, a liquid copper oxide-containing reaction product is formed. The temperature of the whole reaction unit B reaches more than 70° C. due to the reaction heat. Therefore, the copper oxide-containing reaction product is charged into the pressure filtering unit C through the copper oxide-containing reaction product pipe 90.

The pressure filtering unit C can be a conventional solid/liquid separation device using pressure, such as a press. The operation pressure is at least 6 kg. The pressure filtering unit C includes a copper oxide-containing solid outlet 100 and a filtrate pipe 110. The copper oxide-containing reaction product is pressure filtered to obtain a copper oxide-containing solid and a filtrate. The copper oxide-containing solid is taken out from the copper oxide-containing solid outlet 100. The filtrate can be circulated back to the reaction unit B through the filtrate pipe 110 for adjustment of concentration in the reactor, or fed back as a partial substitute of liquid alkali to a pH adjusting pool of the waste treatment plant.

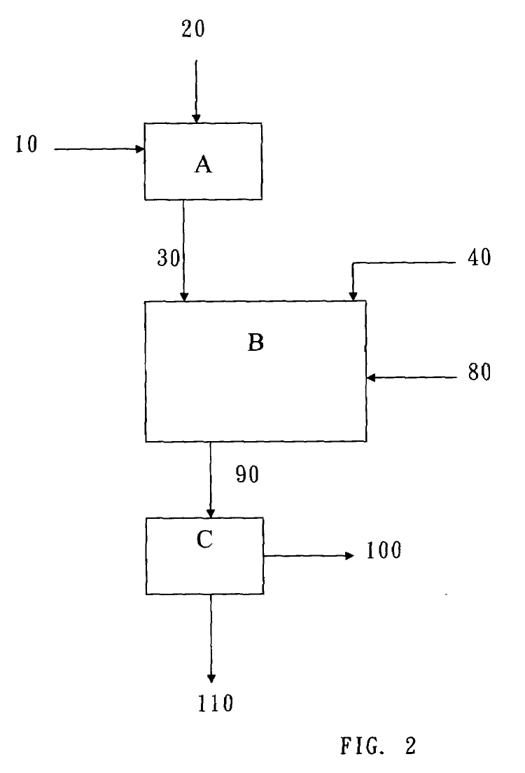

FIG. 2 is a schematic view of a copper recovery system according to a second embodiment of the invention.

Referring to FIG. 2, the slurry preparation unit A includes a sludge cake delivery belt 10, an acidic copper-containing rinsing waste liquid 20 and a slurry pipe 30. In another embodiment, the slurry unit A includes a stirrer (not shown) and a slurry storage container (not shown). The stirrer connects to the sludge delivery belt 10 and an acidic copper oxide-containing rinsing waste liquid 20. The slurry storage container connects to the slurry pipe 30, with a connecting pipe between the stirrer and the slurry storage container.

The reactor B connects to the slurry pipe 30, a liquid alkali pipe 40, a SPS-containing acidic waste liquid 50, a nitric acid pipe 60, and a mixture pipe 80.

The reaction unit B at least includes a reactor (not shown). The reactor preferably includes a stirrer (not shown) for complete reaction. The reaction unit B further includes a copper oxide-containing reaction product storage container connecting to the reactor.

In the case that the reaction unit B includes the reactor and the copper oxide-containing reaction product storage container, the reactor connects to the slurry pipe 30, the liquid alkali pipe 40, and the mixture pipe 80. The copper oxide-containing reaction product storage container connects to the copper oxide-containing reaction product pipe 90, with a connecting pipe between the copper oxide-containing reaction product storage container and the reactor. Optionally, a water pipe (not shown) connects to the reactor to properly adjust the concentration of reaction product in the reactor.

The slurry, liquid alkali, and the liquid alkali are respectively charged into the reactor through the slurry pipe 30 and the liquid alkali pipe 40. The SPS-containing acidic waste liquid, nitric acid and sulfuric acid are collectively charged into the reactor through the mixture pipe 80. After a certain period of time passed, a liquid copper oxide-containing reaction product is formed. The temperature of the whole reaction unit B reaches more than 70° C. due to the reaction heat. Therefore, the copper oxide-containing reaction product is charged into the pressure filtering unit C through the copper oxide-containing reaction product pipe 90.

The pressure filtering unit C can be a conventional solid/liquid separation device using pressure, such as a press. The operation pressure is at least 6 kg. The pressure filtering unit C includes a copper oxide-containing solid outlet 100 and a filtrate pipe 110. The copper oxide-containing reaction product is pressure filtered to obtain a copper oxide-containing solid and a filtrate. The copper oxide-containing solid is taken out from the copper oxide-containing solid outlet 100. The filtrate can be circulated back to the reaction unit B through the filtrate pipe 110 for adjustment of concentration in the reactor, or fed back as a partial substitute of liquid alkali to a pH adjusting pool of the waste treatment plant.

### EXAMPLES

### Example 1

1000 kg of acidic copper-containing rinsing waste liquid and 1000 kg of copper-containing sludge cake are thoroughly in the slurry preparation unit A to form copper-containing slurry.

650 kg of liquid alkali, 600 kg of mixture of SPS-containing acidic waste liquid, nitric acid and sulfuric acid, and the obtained copper-containing slurry are added into the reaction unit. After the reaction is completed, the copper oxide-containing reaction product is delivered to the pressure filtering unit for pressure filtering and drying. About 480 kg of copper oxide solid and about 2755 kg of filtrate are obtained. The ratio of copper oxide based on the total weight of copper oxide solid is about 20%.

### Example 2

1200 kg of acidic copper-containing rinsing waste liquid, 500 kg of copper-containing sludge cake, and 500 kg copper-containing slurry are thoroughly in the slurry preparation unit A to form copper-containing slurry.

800 kg of liquid alkali, 1000 kg of mixture of SPS-containing acidic waste liquid, nitric acid and sulfuric acid, and the obtained copper-containing slurry are added into the reaction unit. After the reaction is completed, the copper oxide-containing reaction product is delivered to the pressure filtering unit for pressure filtering and drying. About 375 kg of copper oxide solid and about 3220 kg of filtrate are obtained. The ratio of copper oxide based on the total weight of copper oxide solid is about 40%.

In light of the above description, the system and the process of the invention uses all wastes, waste liquids or effluents from the manufacturing processes in situ, except liquid alkali. Therefore, treatment by outsider can be figured out in situ. Furthermore, the product of the inventive process has high economic value as a raw material for copper refinery, which increases the manufacturer's profits in addition to solve the pollution issues.

Compared to conventional technology using strong acid and strong oxidants to crack so as to increase the copper recovery yield, the process and system of the invention need not use any strong oxidants at the first step, but form a stirrable slurry instead. Therefore, no strong oxidant is needed and no concern about harmful gas leaking out during the treatment to hurt human being and living environment.

The acidic copper-containing rinsing waste liquid used in the invention has much lower erosion than pure strong acid and does not generate a lot of smokes during treatment. Therefore, compared to the conventional technology, the copper recovery process according to the invention has significantly high operation safety, while solve most wastes, waste liquids and effluents generated in the manufacture processes in situ.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

What is claimed is:

1. A copper recovery process, at least comprising:
mixing a sludge cake with an acidic copper-containing rinsing waste liquid to obtain a slurry;
reacting SPS-containing waste liquid, nitric acid, sulfuric acid, liquid alkali with the slurry to obtain a copper oxide-containing reaction product; and
press filtering the obtained copper oxide-containing reaction product to obtain a copper oxide-containing solid and a filtrate.

2. The copper recovery process of claim 1, further comprising drying the copper oxide-containing solid to obtain copper oxide solid.

3. The copper recovery process of claim 2, wherein the ratio of copper oxide based on copper oxide solid is about 20 wt %, and water based on copper oxide solid is about 10 wt %.

4. The copper recovery process of claim 1, wherein one weight part of sludge cake is mixed with at least one weight part of acidic copper-containing rinsing waste liquid while stirring thoroughly to form slurry.

5. The copper recovery process of claim 1, wherein the sludge cake includes dry slurry.

6. The copper recovery process of claim 1, wherein the pH value of the obtained slurry is controlled at higher than 2.

7. The copper recovery process of claim 1, wherein alkaline high-concentration slurry and acidic copper-containing rinsing waste liquid are used to adjust pH value of the slurry.

8. The copper recovery process of claim 4, wherein the more than 0.5 weight parts of SPS acidic waste liquid, nitric acid and sulfuric acid, at least 17% of liquid alkali based on the total weight of SPS-containing acidic waste liquid, nitric acid, sulfuric acid and slurry are used.

9. The copper recovery process of claim 1, wherein the pH value during reaction is at least 12.

10. The copper recovery process of claim 1, wherein nitric acid and sulfuric acid are commercially available ones, or high-concentration strong waste liquid.

11. The copper recovery process of claim 1, wherein high-concentration strong acid waste liquid includes copper-containing material.

12. The copper recovery process of claim 1, wherein the pH value of the obtained copper oxide-containing reaction product is 8.5-9.5.

13. The copper recovery process of claim 1, wherein copper oxide-containing solid has about 50 wt %-70 wt %, and about 10 wt % of copper.

14. A copper recovery system, comprising:
a slurry preparation unit, in which slurry cake and acidic copper-containing rinsing waste liquid are mixed to form slurry;
a reaction unit, connecting to the slurry preparation unit and the pressure filtering unit, wherein the slurry, liquid alkali, SPS-containing acidic waste liquid, nitric acid and sulfuric acid react with one another to form a copper oxide-containing reaction product; and
a pressure filtering unit, in which the copper oxide-containing reaction product is pressure filtered to obtain copper oxide-containing solid.
